(19) United States
(12) Patent Application Publication
(10) Pub. No.: US 2021/0170765 A1
(43) Pub. Date: Jun. 10, 2021

(54) LIQUID EJECTING APPARATUS

(71) Applicant: SEIKO EPSON CORPORATION, Tokyo (JP)

(72) Inventor: Yuki SHIOHARA, MATSUMOTO-SHI (JP)

(21) Appl. No.: 17/113,579

(22) Filed: Dec. 7, 2020

(30) Foreign Application Priority Data
Dec. 9, 2019 (JP) 2019-221940

(51) Int. Cl. B41J 11/00; B41J 2/14; F26B 21/14; G21K 5/10; B05D 3/06

(52) U.S. Cl. CPC B41J 11/002; B41J 2/14; B05D 3/067; G21K 5/10; F26B 21/14

(57) ABSTRACT

A liquid ejecting apparatus includes a print head that serves as a liquid ejecting unit configured to eject a liquid curable by light irradiation onto a medium and an irradiation unit configured to emit light onto the medium M on which the liquid is ejected. The liquid ejecting apparatus also includes a depressurizing mechanism that serves as an oxygen concentration reduction mechanism configured to lower an oxygen concentration to a level below an oxygen concentration of the atmosphere in an ejection region formed between the print head and the medium when the print head ejects the liquid and also in an irradiation region formed between the irradiation unit and the medium when the irradiation unit emits light.

The present application is based on, and claims priority from JP Application Serial Number 2019-221940, filed Dec. 9, 2019, the disclosure of which is hereby incorporated by reference herein in its entirety.

### BACKGROUND

### 1. Technical Field

The present disclosure relates to a liquid ejecting apparatus.

### 2. Related Field

JP-A-2019-1115 discloses a liquid ejecting apparatus that includes an image forming unit, an irradiation unit, and an inert gas supplying unit. The image forming unit ejects a UV curable ink onto a surface of a substrate. The irradiation unit is disposed at a position downstream of the image forming unit in a substrate transporting direction and irradiates the substrate with active energy rays. The inert gas supplying unit has a discharge nozzle located between the image forming unit and the irradiation unit in the substrate transporting direction, and the discharge nozzle discharges an inert gas downstream onto the substrate.

The liquid ejecting apparatus disclosed in JP-A-2019-1115, however, may lower the curing performance of the UV curable ink since the oxygen concentration in the UV curable ink may increase while the substrate is transported from a region in which the image forming unit supplies the UV curable ink to the substrate to a region in which the discharge nozzle for discharging the inert gas is disposed.

### SUMMARY

According to an aspect of the present disclosure, a liquid ejecting apparatus includes a liquid ejecting unit configured to eject a liquid curable by light irradiation onto a medium, an irradiation unit configured to emit light onto the medium on which the liquid is ejected, and an oxygen concentration reduction mechanism configured to lower an oxygen concentration to a level below an oxygen concentration of the atmosphere in an ejection region formed between the liquid ejecting unit and the medium when the liquid ejecting unit ejects the liquid and also in an irradiation region formed between the irradiation unit and the medium when the irradiation unit emits light.

### BRIEF DESCRIPTION OF THE DRAWINGS

FIG. 1 is a perspective view illustrating an overall configuration of a liquid ejecting apparatus according to a first embodiment.

FIG. 2 is a schematic diagram illustrating a configuration of a liquid supply mechanism and a printing section of the liquid ejecting apparatus.

FIG. 3 is a schematic diagram illustrating a configuration of a liquid supply mechanism and a printing section of a liquid ejecting apparatus according to a second embodiment.

FIG. 4 is a schematic diagram illustrating a configuration of a liquid supply mechanism and a printing section of a liquid ejecting apparatus according to a third embodiment.

### DESCRIPTION OF EXEMPLARY EMBODIMENTS

### 1. First Embodiment

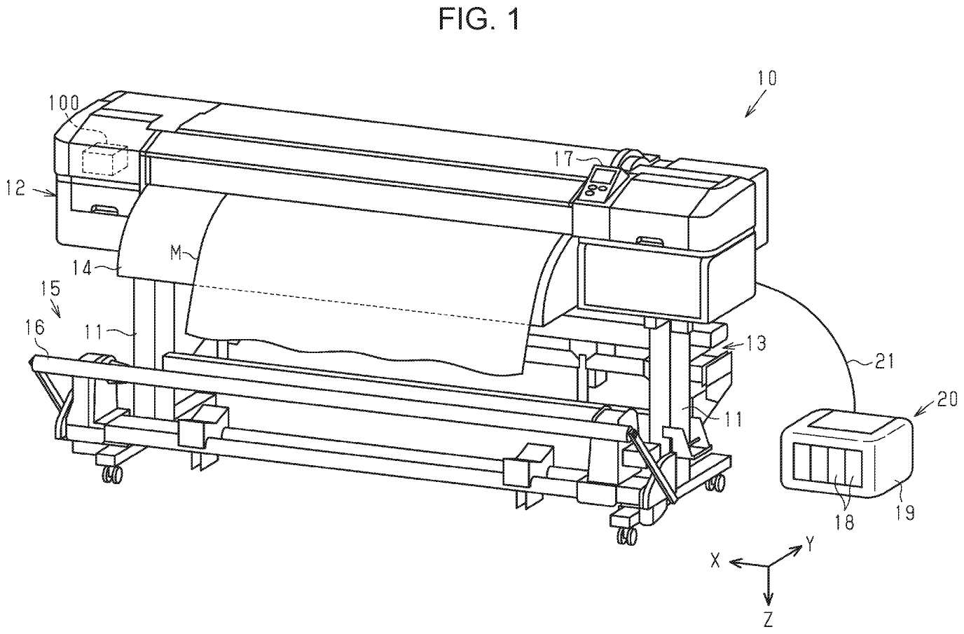

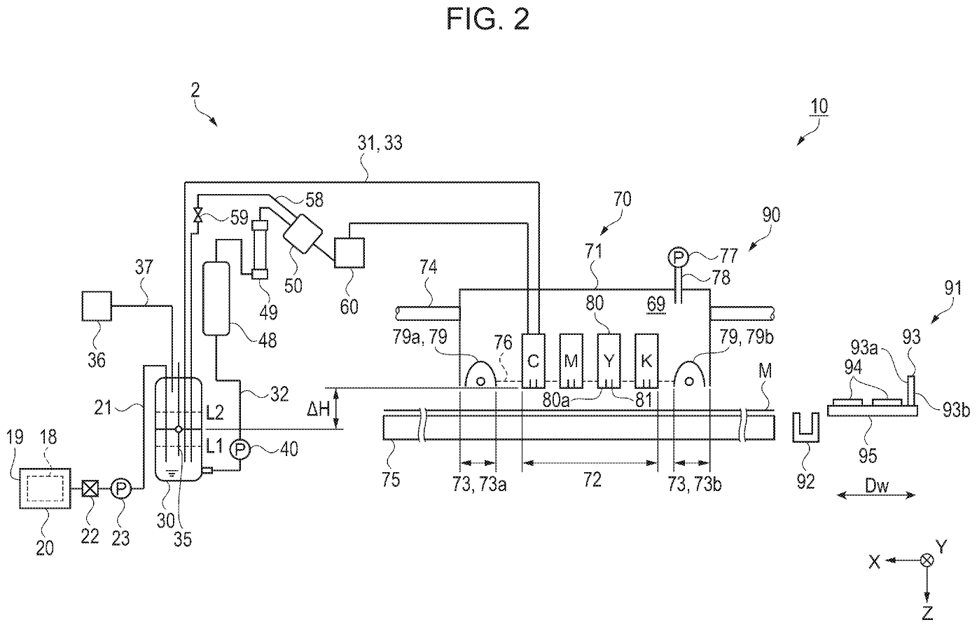

A liquid ejecting apparatus 10 according to a first embodiment will be described with reference to FIGS. 1 and 2. The following description covers an overall configuration of the liquid ejecting apparatus 10, a liquid supply mechanism 2, a printing section 70, and a maintenance mechanism 91 in this order. The liquid ejecting apparatus 10 described in the present embodiment is a serial-type ink jet printer that performs printing by ejecting a liquid onto a medium M, such as a sheet of paper, and the liquid is curable by light irradiation. In the following description, the liquid curable by light irradiation is referred to as a “UV curable ink” or simply referred to as a “liquid”.

### 1-1 Overall Configuration of Liquid Ejecting Apparatus

In the following description, assuming that the liquid ejecting apparatus 10 is placed on a horizontal surface, the Z-axis extends in the vertical direction, in other words, in the direction in which gravity acts, and the X-axis and the Y-axis extend in directions parallel to the horizontal surface that perpendicularly intersects the vertical direction. The X-axis, the Y-axis, and the Z-axis orthogonally intersect each other. The pointed end of each arrow that represents each axis points toward the “plus side” on the axis, whereas the other end of the arrow points toward the “minus side” on the axis. In the following description, a direction parallel to the X-axis may be referred to as the “width direction”, and a direction parallel to the Y-axis may be referred to as the “depth direction”. In the liquid ejecting apparatus 10, the +z side along the Z-axis may be referred to as a “bottom side” or a “lower side”, and the −z side along the Z-axis may be referred to as a “top side” or an “upper side”.

As illustrated in FIG. 1, the liquid ejecting apparatus 10 includes a pair of legs 11, a housing 12, a feed section 13, a guide section 14, a winding section 15, a tension-imparting mechanism 16, and an operation panel 17. The housing 12 is joined to upper portions of respective legs 11. The feed section 13 feeds a medium M wound in a roll toward the inside of the housing 12. The guide section 14 guides the medium M discharged from the housing 12 toward the winding section 15.

The winding section 15 winds the medium M guided by the guide section 14 into a roll. The tension-imparting mechanism 16 applies tension to the medium M to be wound by the winding section 15. The operation panel 17 allows a user to input various operational conditions to be executed by the liquid ejecting apparatus 10.

The liquid ejecting apparatus 10 also includes a main tank 20. The main tank 20 is provided outside the housing 12. The main tank 20 includes liquid containers 18 for storing liquids and a holder 19 that holds the liquid containers 18. The liquid containers 18 are ink cartridges for accommodating inks, which are examples of the liquids. The holder 19 detachably holds the liquid containers 18.

The liquid ejecting apparatus 10 also includes a control unit 100 configured to control operation of the liquid ejecting apparatus 10. For example, the control unit 100 has CPU and memory. The CPU is an arithmetic processing unit for controlling operation of each unit of the liquid ejecting apparatus 10. The memory is a storage device, such as RAM or EPROM, that has an area for storing a program to be executed by the CPU and also has a work area to be used during execution of the program. The CPU executes the program stored in the memory, and the control unit 100 thereby controls operation of the liquid ejecting apparatus 10.

### 1-2 Liquid Supply Mechanism

As illustrated in FIG. 2, the liquid ejecting apparatus 10 includes the liquid supply mechanism 2 and print heads 80 that serve as a liquid ejecting unit. The liquid supply mechanism 2 includes, for example, a sub-tank 30 and a circulation line 31.

The sub-tank 30 temporarily stores a liquid supplied from the main tank 20. The sub-tank 30 of the present embodiment is an open tank. A liquid level of the sub-tank 30 is the height of the surface of the liquid in the sub-tank 30.

Each print head 80 includes a nozzle face 80a and multiple nozzles 81 formed at the nozzle face 80a and arrayed along the Y-axis. The nozzles 81 eject the liquid. The vertical distance between the level of the nozzle face 80a and the liquid level of the sub-tank 30 is a head difference ΔH.

The circulation line 31 is a flow channel for the circulation of the liquid. The liquid circulating in the circulation line 31 is supplied from the sub-tank 30 to the print head 80 and is returned from the print head 80 to the sub-tank 30.

The main tank 20 communicates with the sub-tank 30 through a replenishing line 21. The replenishing line 21 is a flow channel for replenishing the sub-tank 30 with the liquid supplied from the main tank 20. The upstream end of the replenishing line 21 is connected to the main tank 20. The downstream end of the replenishing line 21 is connected to the sub-tank 30.

A supply on-off valve 22 and a supply pump 23 are disposed in this order in the replenishing line 21 from the main tank 20 to the sub-tank 30. The supply on-off valve 22 is, for example, a solenoid valve that opens and closes the replenishing line 21. The supply pump 23 causes the liquid stored in the main tank 20 to flow toward the sub-tank 30.

The sub-tank 30 has a liquid-level sensor 35. The liquid-level sensor 35 detects the liquid level of the sub-tank 30. The liquid-level sensor 35 determines whether the liquid level of the sub-tank 30 is not less than a first liquid level L1. The liquid-level sensor 35 determines whether the liquid level of the sub-tank 30 is not less than a second liquid level L2 that is a level higher than the first liquid level L1.

The supply on-off valve 22 and the supply pump 23 supply or stop supplying the liquid from the main tank 20 to the sub-tank 30. When the liquid level of the sub-tank 30 is less than the first liquid level L1, the supply on-off valve 22 and the supply pump 23 starts supplying the liquid. When the liquid level of the sub-tank 30 exceeds the second liquid level L2, the supply on-off valve 22 and the supply pump 23 stops supplying the liquid. Accordingly, the liquid level of the sub-tank 30 is kept between the first liquid level L1 and the second liquid level L2.

Note that the supply on-off valve 22 and the supply pump 23 may supply the liquid when the print head 80 consumes the liquid. Moreover, the supply on-off valve 22 and the supply pump 23 may supply the liquid so as to control the pressure of the liquid in the print head 80 within a predetermined range. With this liquid replenishment method, the liquid pressure can be controlled at the nozzles 81 within an appropriate range while the liquid circulates in the circulation line 31. In other words, the liquid can circulate in the circulation line 31 without disturbing a meniscus that is a gas-liquid interface formed in each nozzle 81.

The inside of the sub-tank 30 is open to the atmosphere when the liquid ejecting apparatus 10 performs printing. Opening the sub-tank 30 to the atmosphere is performed by adjusting the internal pressure of the sub-tank 30. The internal pressure of the sub-tank 30 is adjusted without breaking the meniscus formed in each nozzle 81. The internal pressure of the sub-tank 30 is, for example, −3500 Pa or more and −1000 Pa or less relative to atmospheric pressure. The adjustment of the internal pressure of the sub-tank 30 can stabilize the meniscus of the nozzle 81.

Note that the adjustment of internal pressure of the sub-tank 30 may be performed by adjusting the head difference ΔH. For example, the supply on-off valve 22 and the supply pump 23 may adjust the liquid level of the sub-tank 30 so as to cause the head difference ΔH to be 190 mm.

The sub-tank 30 communicates with a pressurizing module 36 through an air channel 37. Air is supplied to or discharged from the inside of the sub-tank 30 through the air channel 37. The pressurizing module 36 pressurizes the liquid in the sub-tank 30 by supplying air through the air channel 37 and depressurizes the liquid by discharging air through the air channel 37.

The pressurizing module 36 is used, for example, for performing pressurized cleaning. In the pressurized cleaning, the liquid supplied to the nozzles 81 is pressurized so that the liquid is forcibly discharged from the nozzles 81. The pressurized cleaning is performed to discharge foreign matter, such as bubbles, contained in the liquid out of the print head 80. In the pressurized cleaning, the pressurizing module 36 increases the internal pressure of the sub-tank 30 so as to break the meniscus of the nozzle 81.

The pressurizing module 36 may be used to adjust the internal pressure of the sub-tank 30 when, for example, the liquid ejecting apparatus 10 performs printing. The pressurizing module 36 controls the internal pressure of the sub-tank 30, for example, in a range of −2400 Pa or more and −1900 Pa or less relative to atmospheric pressure, so as not to break the meniscus of the nozzle 81. The adjustment of the internal pressure of the sub-tank 30 by means of the pressurizing module 36 can also stabilize the meniscus of each nozzle 81.

The circulation line 31 includes a liquid supply line 32 and a liquid discharge line 33. The liquid is supplied from the sub-tank 30 toward print head 80 through the liquid supply line 32. The upstream end of the liquid supply line 32 is connected to the sub-tank 30. The downstream end of the liquid supply line 32 is connected to the print head 80.

A portion of the liquid supplied to the print head 80 is returned toward the sub-tank 30 through the liquid discharge line 33. In other words, a portion of the liquid supplied to the print head 80, which is not discharged from the nozzles 81 of the print head 80, is returned to the sub-tank 30 through the liquid discharge line 33. The upstream end of the liquid discharge line 33 is connected to the print head 80. The downstream end of the liquid discharge line 33 is connected to the sub-tank 30.

The liquid supply line 32 is connected to one end portion of each print head 80. The liquid discharge line 33 is connected to the other end portion of each print head 80.

A diaphragm pump 40, a heating unit 48, a deaeration mechanism 49, a filter 50, and a damper 60 are disposed in this order in the liquid supply line 32 from the sub-tank 30 toward the print head 80.

The diaphragm pump 40 is an example of a pump. The diaphragm pump 40 supplies the liquid to the print head 80 through the liquid supply line 32.

It is preferable that at least part of the diaphragm pump 40 be positioned below the liquid level of the sub-tank 30. It is more preferable that the center of diaphragm chamber of the diaphragm pump 40 in the vertical direction be positioned below the liquid level of the sub-tank 30. In the case of the inlet of the diaphragm pump 40 being positioned below the liquid level of the sub-tank 30, the occurrence of cavitation can be suppressed and the liquid supply of the diaphragm pump 40 can be thereby stabilized.

The heating unit 48 includes a heated-water tank having a heater and a thermometer, a heated-water circulation line, a heated-water pump, and a heat exchanger. The heated-water tank stores heated water having a temperature adjusted in a predetermined range. The heated-water circulation line is a flow channel routing from the heated-water tank to the heated-water tank via the heat exchanger. The heated-water pump circulates the heated water in the heated-water circulation line. The heat exchanger exchanges heat between the heated water flowing through the heated-water circulation line and the liquid flowing through the circulation line 31.

The heating unit 48 heats the liquid flowing through the circulation line 31 to a predetermined temperature. The predetermined temperature is a temperature at which the liquid supplied to the print head 80 has a viscosity suitable for ejection from the print head 80, which is 35° C. or more and 40° C. or less, for example. The heating unit 48 reduces the likelihood of a highly viscous liquid not suitable for ejection being supplied to the print head 80.

The deaeration mechanism 49 deaerates the liquid supplied to the print head 80, in other words, the liquid flowing through the circulation line 31. The deaeration mechanism 49 has a deaeration module and a decompressor. For example, the deaeration module has a plurality of hollow fiber membranes. The decompressor reduces the pressure outside the hollow fiber membranes, and the liquid flowing through the hollow fiber membranes is deaerated. The deaeration mechanism 49 reduces the likelihood of the bubble-containing liquid being supplied to the print head 80.

The filter 50 disposed in the liquid supply line 32 is positioned above the level of the nozzle face 80a of the print head 80 in the vertical direction. The filter 50 is detachably disposed in the liquid supply line 32. The liquid from which foreign matter such as bubbles is removed at the filter 50 flows downstream into the liquid supply line 32.

The damper 60 reduces pressure fluctuation of the liquid flowing through the circulation line 31. For example, the damper 60 is a permeable membrane having rubber elasticity.

A deaeration line 58, which is different from the liquid supply line 32, is connected to an upstream portion of the filter 50. The deaeration line 58 connects the filter 50 and the sub-tank 30. A discharge valve 59 is disposed at an intermediate portion of the deaeration line 58. The deaeration line 58 is connected to a nearly uppermost portion of the filter 50 in the vertical direction.

The discharge valve 59 switches the state of the deaeration line 58 between a communicating state and a non-communicating state. Bubbles captured at the filter 50 are discharged to the sub-tank 30 through the deaeration line 58 while the discharge valve 59 in the deaeration line 58 is open.

### 1-3 Printing Section

The liquid ejecting apparatus 10 includes the printing section 70 for performing printing on a medium M supplied from the feed section 13 to the inside of the housing 12. The printing section 70 includes print heads 80 as described above, a carriage 71, irradiation units 79, an ejection region 72, irradiation regions 73, a depressurizing mechanism 90 that serves as an oxygen concentration reduction mechanism, and a platen 75. The carriage 71 is shaped like a box of which the bottom side is open, and the bottom side is sealed by an oxygen permeable membrane 76, which will be described later. The print heads 80, the irradiation units 79, and part of the depressurizing mechanism 90 are mounted in the carriage 71 that is located above the platen 75. The carriage 71 is guided by a guide shaft 74 disposed along the X-axis and is configured to move reciprocally in the X direction, which is the main scanning direction. The irradiation units 79 are a first irradiation unit 79a and a second irradiation unit 79b. The first irradiation unit 79a, the print heads 80, and the second irradiation unit 79b are mounted in the carriage 71 in this order from the +x side to the −x side of the X-axis. The platen 75 is disposed so as to oppose the carriage 71 that moves reciprocally. The platen 75 supports the medium M from below. The medium M is transported in a transporting direction that extends from the +y side to the −y side of the Y-axis.

Each print head 80 ejects a UV curable ink onto the medium M. The printing section 70 of the present embodiment has four print heads 80 that are arrayed along the X-axis. Each print head 80 has a nozzle face 80a at which multiple nozzles 81 for ejecting the UV curable ink are arrayed along the Y-axis. For example, the four print heads 80 correspond to respective four colors, in other words, cyan (C), magenta (M), yellow (Y), and black (K). Ejection of the UV curable ink from each print head 80 is controlled by the control unit 100. Note that the number of print heads 80 mounted in the printing section 70 may be three or less or may be five or more.

The medium M on which the UV curable ink has been ejected is irradiated with light by a corresponding irradiation unit 79. Each irradiation unit 79 includes a light source that emits light for curing the UV curable ink to the medium M. Various types of the light sources are usable, such as a light emitting diode (LED), a laser diode (LD), a mercury lamp, a metal halide lamp, a xenon lamp, or an excimer lamp. The length of the irradiation unit 79 along the Y-axis is such as to cover the entire nozzles 81 that are disposed in each print head 80 and arrayed along the Y-axis. In the first embodiment, two irradiation units 79 are provided. The number of the irradiation units 79 may be two or more. For example, one irradiation unit 79 may be provided for each print head 80. When the carriage 71 moves toward the +x side of the X-axis, the second irradiation unit 79b located downstream of the four print heads 80 is activated. On the other hand, when the carriage 71 moves toward the −x side of the X-axis, the first irradiation unit 79a located downstream of the four print heads 80 is activated. The irradiation units 79 are controlled by the control unit 100.

The ejection region 72 is a space formed between the print heads 80 and the medium M when each print head 80 ejects the UV curable ink. The irradiation regions 73 are spaces formed between respective irradiation units 79 and the medium M when the irradiation units 79 emit light. A first irradiation region 73a corresponds to the first irradiation unit 79a, and a second irradiation region 73b corresponds to the second irradiation unit 79b. The size of the ejection region 72 and the sizes of the first and second irradiation regions 73a and 73b are not specifically limited here. The ejection region 72 and the first and second irradiation regions 73a and 73b move over the medium M when the carriage 71 moves in the X direction. When the carriage 71 moves toward the +x side of the X-axis, the ejection region 72 first moves toward +x side, and subsequently the second irradiation region 73b comes to the previous position of the ejection region 72 to cure the UV curable ink. On the other hand, when the carriage 71 moves toward the −x side of the X-axis, the ejection region 72 first moves toward −x side, and subsequently the first irradiation region 73a comes to the previous position of the ejection region 72 to cure the UV curable ink.

The depressurizing mechanism 90 serves to lower oxygen concentration in the ejection region 72 and also in the irradiation regions 73 to a level below the oxygen concentration of the atmosphere. The depressurizing mechanism 90 has the oxygen permeable membrane 76, a depressurizing pump 77, and a pipe 78.

The oxygen permeable membrane 76 can transmit oxygen selectively. For example, the oxygen permeable membrane 76 may be a dense film that utilizes electroconductivity to pass specific ions selectively with the pressure difference in oxygen concentration serving as the drive force. The oxygen permeable membrane 76 covers the bottom side of the carriage 71 entirely except for the bottom surfaces of the print heads 80 and of the irradiation units 79. The space surrounded by the oxygen permeable membrane 76 and the carriage 71 is a depressurized region 69. In other words, the oxygen permeable membrane 76 serves as a partition that separates the depressurized region 69 from the ejection region 72 and from the irradiation regions 73. Note that in the present embodiment, the oxygen permeable membrane 76 forms the entire partition. However, the oxygen permeable membrane 76 may be configured to form part of the partition. More specifically, the oxygen permeable membrane 76 may be disposed at least upstream of the ejection region 72 in the moving direction of the carriage 71.

The depressurizing pump 77 is a pump that can reduce the pressure in the depressurized region 69. For example, the depressurizing pump 77 may be a diaphragm pump. A plurality of the depressurizing pumps 77 may be provided. It is sufficient that the depressurizing pump 77 is able to lower the pressure at least below atmospheric pressure. The depressurizing pump 77 is connected to the depressurized region 69 via the pipe 78. The pipe 78 may be connected to any portion of the carriage 71 that forms the depressurized region 69 in collaboration with the oxygen permeable membrane 76.

The depressurizing mechanism 90 lowers the oxygen concentration in a manner as described below. Due to the depressurizing pump 77 depressurizing the depressurized region 69, the oxygen content of the air inside the depressurized region 69 is lowered relative to that in the ejection region 72 and in the irradiation regions 73. The oxygen content per unit volume becomes different between the depressurized region 69 and the ejection region 72 and the irradiation regions 73. Due to this difference in the oxygen content serving as the drive force, oxygen in the ejection region 72 and in the irradiation regions 73 moves to the depressurized region 69 through the oxygen permeable membrane 76. Thus, the oxygen concentration becomes low in the ejection region 72 and in the irradiation regions 73.

### 1-4 Maintenance Mechanism

The liquid ejecting apparatus 10 includes the maintenance mechanism 91 for the maintenance of the print heads 80 to stabilize liquid ejection onto the medium M.

The maintenance mechanism 91 is formed of a flushing box 92, a wiper 93, caps 94, and a support member 95 for movably supporting these components together. In wiping, the wiper 93 having a wiping face 93a and a wiping face 93b moves in a wiping direction Dw with the wiping face 93a or the wiping face 93b being in contact with the nozzle faces 80a. In capping, the caps 94 come into contact with corresponding nozzle faces 80a so as to cover the nozzles 81 at a position at which the caps 94 overlap the print heads 80 as viewed in plan along the Z-axis. Moreover, the carriage 71 periodically moves to a position at which the carriage 71 overlaps the flushing box 92 as viewed in plan along the Z-axis, and each print head 80 ejects liquid into the flushing box 92. The maintenance mechanism 91 is provided at a position different from the position of the platen 75 along the X-axis. Along the Z-axis, the maintenance mechanism 91 may be positioned differently from the platen 75. In addition, when the maintenance mechanism 91 performs maintenance of the print heads 80 or when the carriage 71 is positioned vertically above the maintenance mechanism 91, the depressurizing mechanism 90 may stop operation.

The maintenance mechanism 91 also includes a maintenance activation mechanism to drive the wiper 93 and the caps 94. The maintenance activation mechanism is configured to move the wiper 93 and the caps 94 along the Z-axis. The maintenance activation mechanism also moves the wiper 93 along the X-axis and raise or lowers the caps 94 along the Z-axis.

Note that in the present embodiment, the deaeration mechanism 49 is disposed between the heating unit 48 and the filter 50. The deaeration mechanism 49, however, may be disposed inside the carriage 71. Since the inside of the carriage 71 is depressurized by the depressurizing pump 77, the deaeration mechanism 49 can be formed only of the deaeration module. In other words, the depressurizing pump 77 of the depressurizing mechanism 90 can serve as the decompressor of the deaeration mechanism 49, which can reduce the number of pumps included in the liquid ejecting apparatus 10.

The liquid ejecting apparatus 10 according to the present embodiment can provide advantageous effects as described below.

The liquid ejecting apparatus 10 includes the oxygen concentration reduction mechanism that lowers oxygen concentration in the ejection region 72 and in the irradiation regions 73 to a level below the oxygen concentration of the atmosphere. In other words, the oxygen concentration is lowered in the ejection region 72 in which the UV curable ink is ejected and in the irradiation regions 73 in which light for curing the UV curable ink is emitted, which can improve the curing performance of the UV curable ink.

The liquid ejecting apparatus 10 includes the depressurizing mechanism 90 that serves as the oxygen concentration reduction mechanism. The depressurizing mechanism 90 reduces the oxygen content in the depressurized region 69 using the depressurizing pump 77 and moves oxygen from the ejection region 72 and the irradiation regions 73 to the depressurized region 69 using the oxygen permeable membrane 76. The oxygen concentration can be thereby lowered advantageously in the ejection region 72 and in the irradiation regions 73 to a level below the oxygen concentration in the atmosphere.

The liquid ejecting apparatus 10 includes the deaeration mechanism 49 that deaerates the liquid to be supplied to the print heads 80. This reduces the amount of bubbles contained in the liquid ejected from the print heads 80. In other words, this reduces the oxygen content dissolved in the UV curable ink. As a result, the curing performance of the UV curable ink can be improved.

The liquid ejecting apparatus 10 includes the maintenance mechanism 91 for the maintenance of the print heads 80. The liquid adhered to the maintenance mechanism 91 during the maintenance may be cured by light escaped from the irradiation units 79. However, the depressurizing mechanism 90 stops operation during the maintenance, which reduces the likelihood of the liquid adhered to the maintenance mechanism being cured.

### 2. Second Embodiment

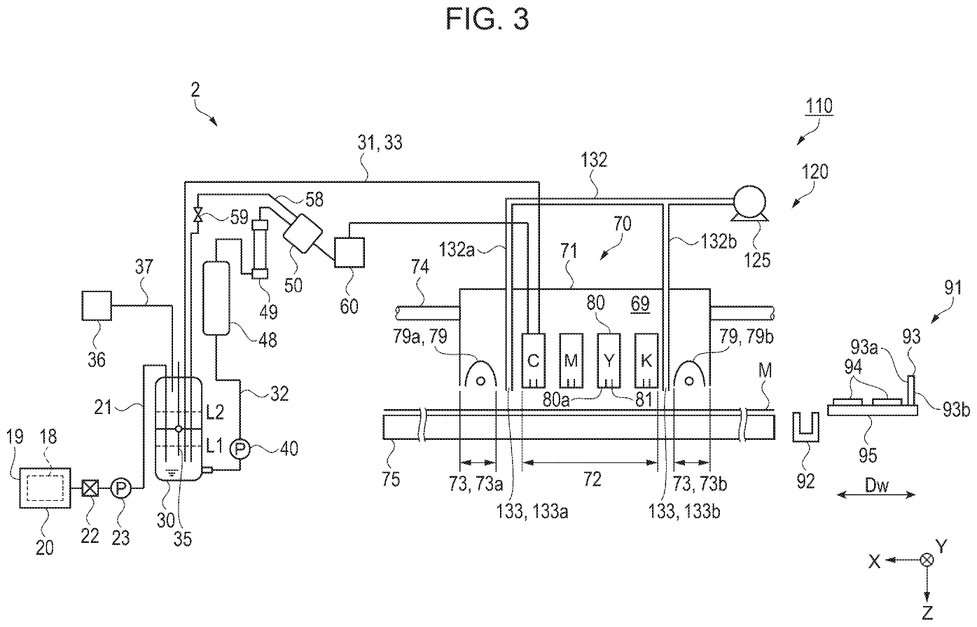

A liquid ejecting apparatus 110 according to a second embodiment will be described with reference to FIG. 3. Note that elements similar to those described in the first embodiment will be denoted by the same reference numerals, and repeated descriptions will be omitted. The liquid ejecting apparatus 110 according to the present embodiment has an oxygen concentration reduction mechanism configured differently from that of the liquid ejecting apparatus 10 described in the first embodiment.

The liquid ejecting apparatus 110 includes an inert gas supply mechanism 120 serving as the oxygen concentration reduction mechanism. For example, the inert gas is nitrogen gas. The inert gas supply mechanism 120 is configured to supply the inert gas to the ejection region 72 and the irradiation regions 73. The inert gas supply mechanism 120 has an inert gas generator 125 serving as the source of the inert gas and an inert gas supply pipe 132. One end of the inert gas supply pipe 132 is connected to the inert gas generator 125. The inert gas supply mechanism 120 is provided to inhibit the UV curable ink from absorbing oxygen in the ejection region 72. The inert gas supply mechanism 120 reduces the oxygen concentration of the air in the irradiation regions 73.

The other end of the inert gas supply pipe 132 has discharge orifices 133 that are positioned upstream of the print heads 80 in the moving direction of the print heads 80 relative to the medium M. More specifically, the inert gas supply mechanism 120 is provided at positions upstream of the carriage 71 in the carriage movement direction when the carriage 71 reciprocally moves along the X-axis. The inert gas supply pipe 132 may be disposed inside or outside of the carriage 71. The inert gas supply pipe 132 according to the present embodiment is formed of a first inert gas supply pipe 132a having a first discharge orifice 133a and a second inert gas supply pipe 132b having a second discharge orifice 133b. The first discharge orifice 133a is disposed between the first irradiation unit 79a and the print heads 80 and the second discharge orifice 133b is disposed between the second irradiation unit 79b and the print heads 80. When the carriage 71 moves toward the +x side of the X-axis, the first discharge orifice 133a discharges the inert gas. When the carriage 71 moves toward the −x side of the X-axis, the second discharge orifice 133b discharges the inert gas. The inert gas supply mechanism 120 is controlled by the control unit 100. Note that the inert gas supply mechanism 120 may be configured to discharge the inert gas simultaneously from the first discharge orifice 133a and from the second discharge orifice 133b irrespective of the movement direction of the carriage 71. In addition, when the maintenance mechanism 91 performs maintenance of the print heads 80 or when the carriage 71 is positioned vertically above the maintenance mechanism 91, the inert gas supply mechanism 120 may stop operation.

The liquid ejecting apparatus 110 according to the present embodiment can provide advantageous effects as below.

As described above, the liquid ejecting apparatus 10 includes the inert gas supply mechanism 120 that serves as the oxygen concentration reduction mechanism. The inert gas supply mechanism 120 supplies the inert gas to the ejection region 72 and the irradiation regions 73. This can lower the oxygen concentration advantageously in the ejection region 72 and in the irradiation regions 73 to a level below the oxygen concentration in the atmosphere.

### 3. Third Embodiment

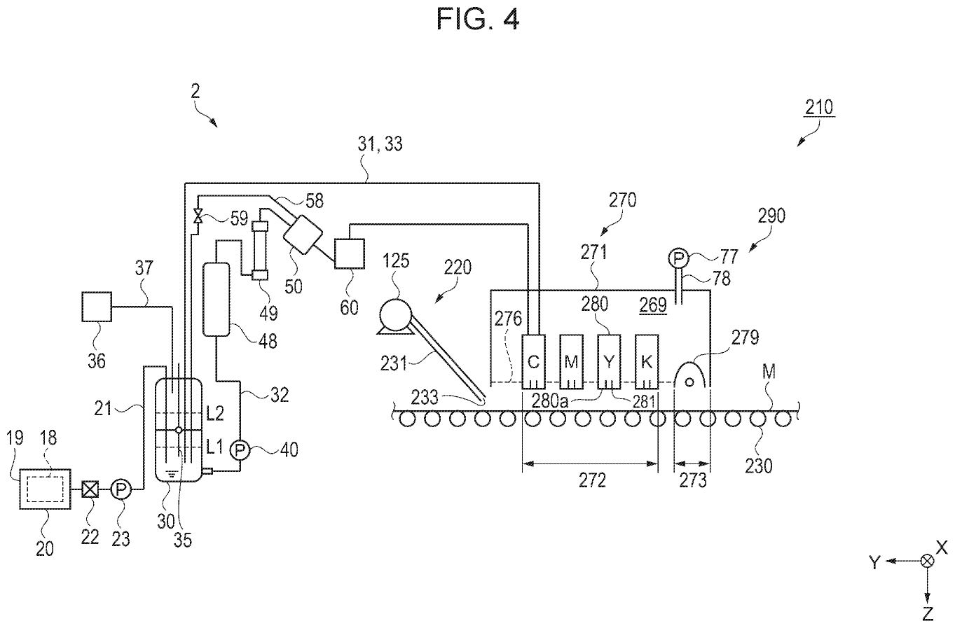

A liquid ejecting apparatus 210 according to a third embodiment will be described with reference to FIG. 4. Elements similar to those described in the first embodiment will be denoted by the same reference numerals, and repeated descriptions will be omitted. The liquid ejecting apparatus 210 of the present embodiment is an ink jet printer of a line-printing type.

The liquid ejecting apparatus 210 includes the printing section 270 for performing printing on a medium M supplied from the feed section 13 to the inside of the housing 12. The printing section 270 includes print heads 280, an irradiation unit 279, an ejection region 272, an irradiation region 273, a depressurizing mechanism 290 and an inert gas supply mechanism 220, both of which serve as the oxygen concentration reduction mechanisms, and medium transport rollers 230. The print heads 280 and the irradiation unit 279 are accommodated in an accommodation box 271 that is shaped as a box of which the bottom side is open. The irradiation unit 279 is disposed downstream of the print heads 280 in a transporting direction of the medium M transported from the +y side toward the −y side of the Y-axis. The accommodation box 271 is formed as a cuboid having a longitudinal length greater than the width of the medium M. The accommodation box 271 is fixed inside the housing 12.

The printing section 270 of the present embodiment has four print heads 280 that are arranged along the Y-axis. Each print head 280 has a nozzle face 280a at which multiple nozzles 281 for ejecting the UV curable ink are arrayed along the X-axis. The length of each print head 280 along the X-axis is greater than the width of the medium M. The medium transport rollers 230, which are disposed so as to oppose the print heads 280, transport the medium M in the transporting direction extending from the +y side to the −y side of the Y-axis.

The ejection region 272 is a space formed between the print heads 280 and the medium M when each print head 280 ejects the UV curable ink. The irradiation region 273 is a space formed between the irradiation unit 279 and the medium M when the irradiation unit 279 emits light. A portion of the medium M located at the ejection region 272 moves to the irradiation region 273 as the medium M is transported.

The depressurizing mechanism 290 serves to lower the oxygen concentration in the ejection region 272 and in the irradiation regions 273 below the oxygen concentration of the atmosphere. The depressurizing mechanism 290 has an oxygen permeable membrane 276, the depressurizing pump 77, and the pipe 78.

The oxygen permeable membrane 276 covers the bottom side of the accommodation box 271 entirely except for the bottom surfaces of the print heads 280 and the irradiation unit 279. The space surrounded by the oxygen permeable membrane 276 and the accommodation box 271 is a depressurized region 269. The depressurizing pump 77 is a pump that can reduce the pressure in the depressurized region 269. The depressurizing pump 77 is connected to the depressurized region 269 via the pipe 78. Due to the depressurizing mechanism 290 depressurizing the depressurized region 269, oxygen in the ejection region 272 and in the irradiation region 273 moves to the depressurized region 269 through the oxygen permeable membrane 276. Thus, the oxygen concentration becomes low in the ejection region 272 and in the irradiation region 273.

The inert gas supply mechanism 220 is configured to supply the inert gas to the ejection region 272 and the irradiation region 273. The inert gas supply mechanism 220 has the inert gas generator 125 and an inert gas supply pipe 231. One end of the inert gas supply pipe 231 is connected to the inert gas generator 125. The other end of the inert gas supply pipe 231 is a discharge orifice 233 that is positioned upstream of the print heads 280 in the transporting direction of the medium M. The inert gas supply pipe 231 is disposed so as to incline, for example, at 45 degrees at a position upstream of the accommodation box 271 in the transporting direction.

The inert gas supply mechanism 220 supplies the inert gas to the ejection region 272 and the irradiation region 273 and thereby reduces the oxygen concentration in the ejection region 272 and the irradiation region 273. The inert gas supply mechanism 220 also serves, like an air curtain, to prevent air present around the medium M from entering the ejection region 272 and the irradiation region 273.

Note that in the present embodiment, one discharge orifice 233 of the inert gas supply mechanism 220 is provided upstream of the accommodation box 271. However, multiple discharge orifices 233 may be disposed along the X-axis. In addition, in the present embodiment, one irradiation unit 279 is provided downstream of the four print heads 280. However, multiple irradiation units 279 may be disposed downstream of respective print heads 280. Moreover, the irradiation unit 279 may have multiple light sources arranged along the X-axis. In addition, when the maintenance mechanism 91 performs maintenance of the print heads 80 or when the carriage 71 is positioned vertically above the maintenance mechanism 91, the depressurizing mechanism 290 and the inert gas supply mechanism 220 may stop operation.

The liquid ejecting apparatus 210 according to the present embodiment can provide advantageous effects as below.

The liquid ejecting apparatus 210 includes the depressurizing mechanism 290 and the inert gas supply mechanism 220, both of which serve as the oxygen concentration reduction mechanism. Accordingly, the oxygen concentration can be reduced effectively in the ejection region 272 and in the irradiation region 273.

What is claimed is:

1. A liquid ejecting apparatus, comprising:
a liquid ejecting unit configured to eject a liquid curable by light irradiation onto a medium;
an irradiation unit configured to emit light onto the medium on which the liquid is ejected; and
an oxygen concentration reduction mechanism configured to lower an oxygen concentration to a level below an oxygen concentration of the atmosphere in an ejection region formed between the liquid ejecting unit and the medium when the liquid ejecting unit ejects the liquid and also in an irradiation region formed between the irradiation unit and the medium when the irradiation unit emits light.

2. The liquid ejecting apparatus according to claim 1, wherein
the oxygen concentration reduction mechanism includes an inert gas supply mechanism configured to supply an inert gas to the ejection region and to the irradiation region.

3. The liquid ejecting apparatus according to claim 2, wherein
the irradiation unit includes a first irradiation unit and a second irradiation unit that are arranged side-by-side with the liquid ejecting unit in a direction orthogonal to a medium transporting direction,
the inert gas supply mechanism includes a first inert gas supply pipe having a first discharge orifice and a second inert gas supply pipe having a second discharge orifice, and
the first discharge orifice is disposed between the first irradiation unit and the liquid ejecting unit, and the second discharge orifice is disposed between the second irradiation unit and the liquid ejecting unit.

4. The liquid ejecting apparatus according to claim 3, wherein
the first irradiation unit and the second irradiation unit are disposed with the liquid ejecting unit interposed therebetween in a direction orthogonal to the medium transporting direction.

5. The liquid ejecting apparatus according to claim 4, wherein
the liquid ejection unit is disposed in a carriage configured to move in a direction orthogonal to the medium transporting direction,
when the carriage moves in a first direction, the inert gas is discharged from the first discharge orifice that disposed in the first direction with respect to carriage, and
when the carriage moves in a second direction that is opposite to the first direction, the inert gas is discharged from the second discharge orifice that disposed in the second direction with respect to carriage.

6. The liquid ejecting apparatus according to claim 1, wherein
the oxygen concentration reduction mechanism includes
a depressurizing pump configured to depressurize a depressurized region and
an oxygen permeable membrane provided as at least part of a partition that separates the depressurized region from the ejection region and the irradiation region.

7. The liquid ejecting apparatus according to claim 6, wherein
the liquid ejecting unit and the irradiation unit are disposed in a carriage configured to move in a direction orthogonal to a medium transporting direction,
the carriage is shaped like a box of which a bottom side is open,
the oxygen permeable membrane covers the bottom side of the carriage except for bottom surfaces of the liquid ejecting unit and the irradiation unit, and
the depressurized region is a region that surrounded by the carriage and the oxygen permeable membrane.

8. The liquid ejecting apparatus according to claim 1, further comprising:
a deaeration mechanism configured to deaerate the liquid to be supplied to the liquid ejecting unit.

9. The liquid ejecting apparatus according to claim 1, further comprising:
a maintenance mechanism that performs maintenance of the liquid ejecting unit, wherein
the oxygen concentration reduction mechanism stops operation during the maintenance.
